(19) United States
(12) Patent Application Publication
(10) Pub. No.: US 2017/0004288 A1
(43) Pub. Date: Jan. 5, 2017

(54) INTERACTIVE AND MULTIMEDIA MEDICAL REPORT SYSTEM AND METHOD THEREOF

(71) Applicant: Tzu-Hung LIN, Taipei (TW)

(72) Inventors: Tzu-Hung LIN, Taipei (TW); Kuang-Lung KO, Taipei (TW); Yi-Ning SU, Taipei (TW)

(21) Appl. No.: 15/198,427

(22) Filed: Jun. 30, 2016

(30) Foreign Application Priority Data
Jul. 1, 2015 (TW) 104121427

(51) Int. Cl. G06F 19/00; G06T 1/00; H04L 29/06; G06K 19/077

(52) U.S. Cl. CPC G06F 19/3487; G06K 19/07758; G06T 1/0021; H04L 63/10; G06F 19/321

(57) ABSTRACT

The present invention is related to an interactive and multimedia medical report system and method thereof. The system comprises a test unit, a marking unit, a database, and an electronic device. The test unit enables generation of an image file, wherein a predefined tag is established in the first position and a special tag is established in the second position. The database is connected to the marking unit and stores the medical report comprising the predefined and special tags, and at least one of the tags established in the image file. The electronic device comprises a processing unit, which makes connections with the database through the communication unit for retrieval of the medical report. The electronic device further comprises a display unit, which is configured to show the predefined tag and the special tag, and at least one of the tags of the image file. The present disclosure further provides an interactive multimedia method for medical report.

The current application claims a foreign priority to application number 104121427 filed on Jul. 1, 2015 in Taiwan.

### FIELD OF THE INVENTION

The present invention is related to medical image report technology, more particularly to interactive and multimedia system, and methods of self-service retrieval applications enabling a patient to read and comprehend the medical report and then give feedback to the medical and professional staff for more detailed explanations in accordance with the present invention.

### BACKGROUND OF THE INVENTION

A conventional method involves medical and professional staffs such as medical examiners, physicians, and or nurses who ask a patient to undertake medical examinations including X-ray tests in order to provide a more accurate diagnosis.

Take X-ray machine for example. The patient who undertook the X-ray examinations have the image profile and therefore the medical and professional staff uses the image profile to identify conditions of the patient and then writes medical report for detailed diagnosis.

The patient depends on the medical and professional staffs for person-to-person assistance in explanations of the medical report that involve with medical expertise. However, the busy schedule of medical and professional staffs has limited their explanations to the parts of abnormal physical conditions or certain physical conditions.

On other hand, the patient expects more detailed explanations apart from the abnormal conditions.

The patient can gain an access to the medical report through the time-consuming application procedures, but the patient cannot fully comprehend the medical report. In other words, an inability to fully comprehend the medical report is very inconvenient to the patient.

Furthermore, the medical and professional staffs could omit certain abnormal physical conditions due to self-efficacy judgments, which could in turn cause a delay in medical treatments.

Accordingly, the present disclosure is directed to an interactive and multimedia medical report system and method thereof to overcome problems associated with the conventional methods.

### SUMMARY OF THE INVENTION

A first objective of the present invention is to provide an interactive and multimedia medical report system wherein a predefined tag is established in a position to enable a patient to read descriptions of the predefined tag related to an image.

A second objective of the present invention according to the interactive and multimedia medical report system is to allow a medical and professional staff to establish a special tag relating to a single and specific, and or abnormal image by adding notes with texts, voices, image, Internet links, colors, and so forth to enhance the readability of the image file.

A third objective of the present invention according to the interactive and multimedia medical report system is enable the patient to effortless read the medical report comprising a three-dimensional picture relating to the image file, and display of the predefined tag and a special tag, and one of the tags.

A fourth objective of the present invention according to the interactive and multimedia medical report system is to allow the patient establish a designation tag at one's discretion in the image file as feedback to the medical and professional staff, and therefore the medical and professional staff can provide a diagnosis based on the designation tag and or at least one of the tags.

A fifth objective of the present invention according to the interactive and multimedia medical report system is related to an imaging recognition technology, which automatically identifies a specific position, and establishes a tag manned or unmanned.

A sixth objective of the present invention according to the interactive and multimedia medical report system includes an identification recognition unit that identifies accessibility of the patient to the medical report and authorizes the medical and professional staff to establish the predefined and special tags, and the designation tag.

A seventh objective of the present invention according to the interactive and multimedia medical report system is to provide an interactive multimedia method to achieve all of the aforementioned objectives.

An eighth objective of the present invention according to the interactive and multimedia medical report system and the method thereof is create an interactive and multimedia method for medical report comprising texts, voices, images, Internet links, and colors, and at least one of said content.

An eighth objective of the present invention according to the interactive and multimedia medical report system and the method thereof is create an interactive and multimedia method for medical report comprising texts, voices, images, Internet links, and colors, and at least one of said content.

To overcome the objects of the invention and other objectives, the present invention is related to an interactive and multimedia medical report system. The system comprises a test unit, a marking unit, a data base, and an electronic device. a test unit to generate an image. The marking unit connecting to the test unit, the marking unit establishing a predefined tag in a first position and a special tag in a second position, wherein the first and second positions can be separated or overlapped, the predefined tag storing a first content and establishing a second content in a special tag. The data base connecting to the marking unit and storing a medical report, wherein the medical report comprising the predefined tag and the special tag, and at least one of the tags of the image file. The electronic device having a processing unit, a communication unit, and a display unit, the processing unit connecting to the data base to access to the medical report, the display unit displaying the predefined and special tags, and at least one of the tags. Wherein select the predefined tag to display the first content and the special tag to display second content,

To overcome the objects of the invention and other objectives, the present invention is related to an interactive and multimedia method for medical report comprising related descriptions to a user. The method according to the present invention comprises: step (a) acquiring image data; step (b) establishing a predefined tag in the first position of the image file manned or unmanned; step (c) establishing a special tag in the second position of the image file manned or unmanned; step (d) storing the predefined and special tags and at least one of tags in the image file to generate the medical report; and step (e) retrieving the medical report for reading the image file through predefined and special tags, and at least one of the tags.

Compared with the conventional methods, the interactive and multimedia medical report system and method thereof according to the present invention allow a patient to comprehend content of the medical report more easily and effortless, without explanations of the medical and professional staff. Accordingly, the present invention can reduce the time medical and professional staff spends on explanations of medical report and concentrate their efforts on diagnosis. In addition, the present invention solves the problems of limited medical resources and overcomes the deficiencies of insufficient explanations of the medical reports provided by the medical and professional staff, as well as mitigates concerns of patients.

Furthermore, the present invention provides methods for the patient who has concerns over a part mentioned or omitted in the medical report can give feedback to the medical and professional staff, and ask for supplementary explanations.

Thus, medical and professional staff can provide supplementary explanations with respect to the parts in more details.

The patient can access to the medical reports securely, repeatedly, at any place and anytime through Internet connections and online identification recognition methods.

### BRIEF DESCRIPTION OF THE DRAWINGS

FIG.1 is a block diagram illustrating a first embodiment of the interactive and multimedia medical report system.

FIG. 2 is a block diagram illustrating a second embodiment of the interactive and multimedia medical report system.

FIG. 3 is a block diagram illustrating a third embodiment of the interactive and multimedia medical report system and method thereof.

FIG. 4 is a flowchart illustrating a fourth embodiment method of the interactive and multimedia medical report.

FIG. 5 is a flowchart illustrating a fifth embodiment method of the interactive and multimedia medical report.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is as below.

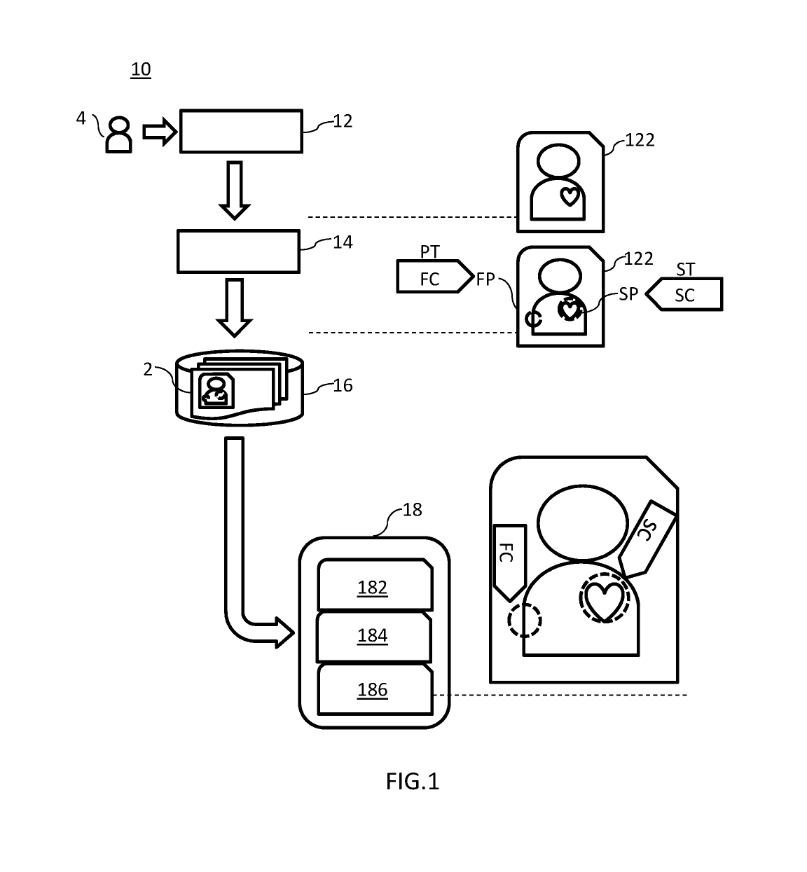

Referring to FIG. 1, there is a block diagram illustrating the interactive and multimedia medical report system in accordance with the present invention. In FIG. 1, the interactive and multimedia medical report system 10 can generate a medical report 2 comprising static and dynamic images, texts, tablets and charts, and voices, and at least one of said content. In this embodiment, the medical report is illustrated as a three-dimensional image.

The interactive and multimedia medical report system 10 comprises a test unit 12, a marking unit 14, a database 16, and an electronic device 18.

The test unit 12 creates an image 122. For example, the test unit 12 can be an X-ray machine.

For example. The medical and professional staff uses X-ray machine to take an x-ray picture of a human body 4 and then converts the x-ray picture of the human body 4 into an image file 122 comprising X-ray pictures of all parts of the human body 4. For example, the human body 4 can be a fetus or newborn baby.

The marking unit 14 is connected to the test unit 12. For example, the marking unit 14 is a computer, which controls the X-ray machine. The marking unit 14 can establish predefined tag PT and special tag ST, and at least one of the tags.

The marking unit 14 establishes the predefined tag PT in the first position FP of the image file 122 such as fingers and then adds texts, voices, images, Internet links, colors, and at least one of the content to the first content FC. In this embodiment of the present invention, the first content FC is text, which defines a normal human has five fingers. The medical and professional staff 2 can decide to change content of the first content FC in the predefined tag PT after identifying the first position FP of the imagine file 122.

The medical and professional staff can use the marking unit 14 to establish the special tag ST in the second position SP such as number of heart beats and then adds text, voices, images, Internet links, colors, and at least one of the content to the second content SC. In this embodiment of the present invention, the second content is voice, which refers to the sound of human heart beats.

In one embodiment of the present invention, the marking unit 14 can identify the first position FP and establish the predefined tag PT and special tag ST, and at least one of the tags in the image file 122 manned or unmanned.

The data base 16 is connected to the marking unit 14. For example. The data base 16 can be installed locally, remotely, on a cloud, and at least one of the locations. The data base 16 stores the medical report 2. In one embodiment of the present invention, the medical report includes three-dimensional images that integrate the processed image file. The three-dimensional images comprise the predefined tag PT, the special tag ST, and at least one of tags of the image file 122. It is worth noting that the data base 16 or electronic device 18 can perform the integration process of image file 122.

In one embodiment of the present invention, the data base 16 can categorizes the same or similar images of the image file 122 into the corresponding predefine tag PT and special tag ST, enabling the same displays of image file 122 in first content FC and second content SC.

In one embodiment of the present invention, the data base 16 can categorizes the same or similar images of the image file 122 into the corresponding predefine tag PT and special tag ST, enabling the same displays of image file 122 in first content FC and second content SC.

Furthermore, the multimedia report can include an introduction content comprising a piece of story or statements that can be added to the beginning, middle, and last sections of the medical report 2.

The electronic device 18 includes a processing unit 182, a communication unit 184, and a display unit 186. For example. The electronic device can be a portable smart device, a computer, a tablet, and a wearable device. The processing unit 182 is connected to the data base 16 through the communication unit 184 for access to medical report 2. The display unit 186 exhibits the predefined tag PT, special tag ST, and at least one of the tags in the image file 122. User can use the electronic device 18 to retrieve and read the medical report 2. It is worth noting that the electronic device 18 can use a programming algorithm to execute imaging process and change sizes, angles, and colors, and at least one of the content of the image file.

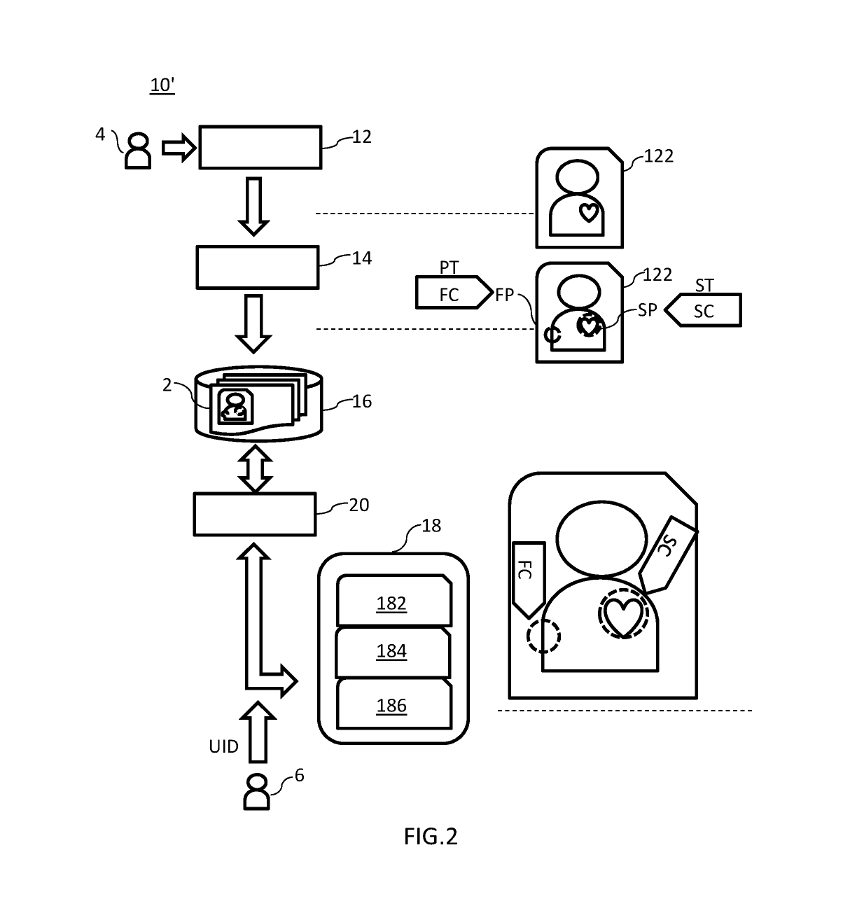

Referring to FIG. 2, there is a block diagram illustrating the interactive and multimedia medical report system in accordance with the invention. In FIG. 2, the interactive and multimedia medical report system 10 includes a test unit 12, a marking unit 14, a data base 16 and an electronic device 18 mentioned in the first embodiment, and an identifier unit 20.

The identifier unit 20 is connected to the data base 16. The identifier unit 20 can identify the UID of a user 6 and then decide whether the user 6 can access to the medical report 2. For example. The identifier unit 20 can identify the UID of the user 6 through biometrics or texted password.

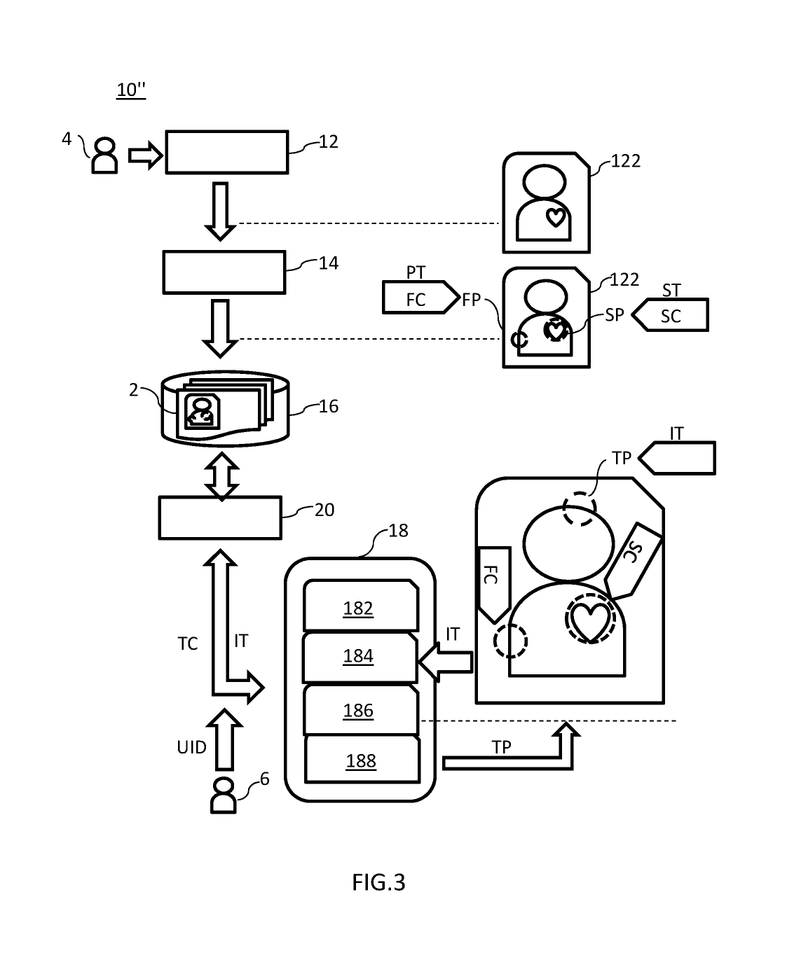

Referred to FIG. 3, there is a block diagram illustrating the interactive and multimedia medical report system in accordance with the invention. In FIG. 3, the interactive and multimedia medical report system 10 includes a test unit 12, a marking unit 14, a data base 16 and an electronic device 18 mentioned in the first embodiment, and the electronic device comprises an input unit 188.

The input unit 188 selects the predefined tag PT, special tag ST, and at least one of the tags in the medical report 2 in order to access to the first content FC and the second content SC.

Furthermore, the input unit 188 can establish a designation tag IT in a third position TP of the medical report 122. For example. The input unit 188 can be a keyboard, an optical mouse, and a touch screen, and so forth. Texts, voices, images, Internet links, colors, and at least one of the content can be added to the designation tag IT. For example. The user 6 can establish the designation tag IT in the medical report 2 at one's discretion and the designation tag IT will be sent back to the data base 16 through the communication unit 184 of the electronic device and then the medical and professional staff can make a response based on the designation tag IT through a third content TC to concerns raised by the user 6.

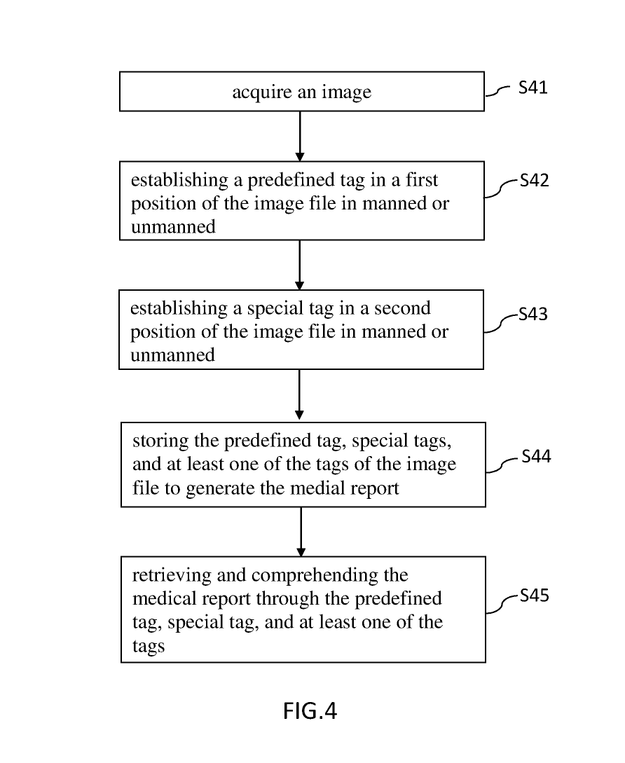

Referred to FIG. 4, there is a flow chart illustrating the method of interactive and multimedia medical report in accordance with the invention. In FIG. 4, the method of interactive and multimedia medical report provides descriptions of a medical report to a user.

The method of interactive and multimedia medical report begins with a step S41 to acquire an image.

Step S42 refers to establishing a predefined tag in a first position of the image file in manned or unmanned. More specifically, the predefined tag provides the same descriptions mentioned above.

Step S43 refers to establishing a special tag in a second position of the image file in manned or unmanned. More specifically, the special tag provides the same descriptions mentioned above.

Step S44 refers to storing the predefined tag, special tags, and at least one of the tags of the image file to generate the medial report. For example. The medical report can be a three-dimensional image.

Step S45 refers to retrieving and comprehending the medical report through the predefined tag, special tag, and at least one of the tags.

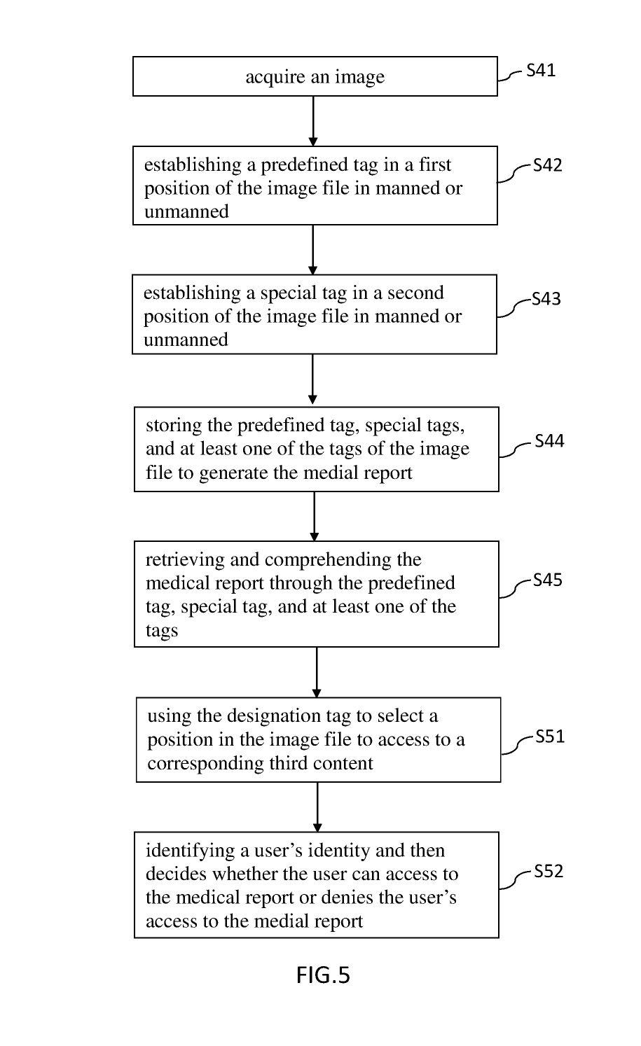

Referred to FIG. 5, there is a flow chart illustrating the method of interactive and multimedia medical report in accordance with the invention. In FIG. 5, the method of interactive and multimedia medical report comprises Steps S41 to S45 mentioned in the fourth embodiment, and steps S51 and S52.

Step S51 refers to using the designation tag to select a position in the image file to access to a corresponding third content. More specifically, the designation tag provides the same descriptions mentioned above.

Step S52 refers to identifying a user's identity and then decides whether the user can access to the medical report or denies the user's access to the medial report.

The present invention is disclosed by the preferred embodiment in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

What is claimed is:

1. An interactive and multimedia medical report system to generate a medical report, the system comprising:
a test unit to generate an image;
a marking unit connecting to the test unit, the marking unit establishing a predefined tag in a first position and a special tag in a second position, wherein the first and second positions can be separated or overlapped, the predefined tag storing a first content and establishing a second content in a special tag;
a data base connecting to the marking unit and storing a medical report, wherein the medical report comprising the predefined tag and the special tag, and at least one of the tags of the image file; and
an electronic device having a processing unit, a communication unit, and a display unit, the processing unit connecting to the data base to access to the medical report, the display unit displaying the predefined and special tags, and at least one of the tags,
wherein select the predefined tag to display the first content and the special tag to display second content.

2. The interactive and multimedia medical report system claimed in claim 1, wherein the electronic device further comprising an input unit to select the predefined and special tags, and at least one of the tags to retrieve the first and second content, respectively.

3. The interactive and multimedia medical report system claimed in claim 2, wherein the input unit establishing a designation tag in a third position wherein texts, voices, images, Internet links, and colors, and at least one of the content are added to the third content.

4. The interactive and multimedia medical report system claimed in claim 1, wherein the marking unit adding text, voice, image, Internet link, color and at least one of the content to the predefined tag, the marking unit adding text, voice, image, Internet link, color and at least one of the content to the special tag.

5. The interactive and multimedia medical report system claimed in claim 1, wherein the medical report comprising static and dynamic image, text, tablet and chart, and voice, and at least one of said content.

6. The interactive and multimedia medical report system claimed in claim 1, wherein the medical report comprising a three-dimensional image integrating the processed image file, enabling the electronic device to use a programming algorithm to execute imaging process and change size, angle, and color, and at least one of the content of the image file.

7. The interactive and multimedia medical report system claimed in claim 1, wherein the marking unit identifying the first position of an image through a programming algorithm and establishing the predefined and special tags and at least one of tags in the image file manned or unmanned.

8. The interactive and multimedia medical report system claimed in claim 1, further comprising an indemnifier unit for indemnifying a user's ID to determinate whether the user can access to the medical report.

9. The interactive and multimedia medical report system claimed in claim 1, further comprising introduction content in the medical report.

10. An method of interactive and multimedia medical report to provide to description of a medical reports to a user, the method comprising steps of:
acquiring an image;
establishing a predefined tag with respect to the image in a first position in manned or unmanned;
establishing a special tag with respect to the image in a second position in manned or unmanned;
storing the predefined and special tags with respect to the image, and at least one of the tags to generate the medical report; and
retrieving the medical report, and comprehending the image file through the predefined and special tags, and at least one of the tags.

11. The interactive and multimedia medical report method claimed in claim 10, further comprising a designation tag in the image file, enabling the selection of a third position to access to the corresponding third content.

12. The interactive and multimedia medical report method claimed in claim 10, further comprising step of identifying a user identity to authorize or deny the accessibility of the medical report.

13. The interactive and multimedia medical report method claimed in claim 10, further comprising the medical report represented as a three-dimensional image including the predefined and special tags, and at least one of the tags, enabling a programming algorithm to change size, angle, and color, and at least one of the content of the image file.
